(19) United States
(12) Patent Application Publication
(10) Pub. No.: US 2003/0229447 A1
(43) Pub. Date: Dec. 11, 2003

(54) Lane position maintenance apparatus and method

(75) Inventors: David J. Wheatley, North Barrington, IL (US); Lawrence Marturano, Palatine, IL (US); Bradford Miller, Chandler, AZ (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/178,095

(22) Filed: Jun. 11, 2002

(51) Int. Cl. G06G 7/78

(52) U.S. Cl. 701/300; 701/301

(57) ABSTRACT

Proximity of a moving vehicle with respect to a lane boundary is ascertained and the degree of proximity is used to provide a variable signal to the driver of the vehicle to alert the driver to such proximity. In one embodiment, the variable signal to the driver includes haptic sensations that are imparted through, for example, the steering wheel and/or the driver's seat. Visual and audible signals can also be used if desired. The signal itself can vary in intensity with respect to boundary proximity in a variety of ways, including through both linear and non-linear patterns, variable maximum signal intensity, and so forth.

### TECHNICAL FIELD

This invention relates generally to terrestrial vehicle lane position maintenance.

### BACKGROUND

Terrestrial vehicles of various sorts are known and include automobiles, trucks, taxiing aircraft, and so forth. Many such vehicles move from place to place by following a predefined lane, such as the lane of a roadway. In some cases the lane constitutes a solitary throughfare, and in other cases the lane comprises a part of a multi-lane pathway (either one-way or two-way in nature). In all cases, however, the lane is circumscribed on both sides by a boundary. This boundary will typically either comprise a junction with another lane (or a transition section or island that separates the two) or the lateral terminus of the thoroughfare (such as a curb or other material boundary).

Terrestrial vehicles traveling in such lanes tend to be piloted by a human driver. Such drivers are subject to ordinary human frailties such as distractability, drowsiness, and the like. As a result, vehicles piloted by such drivers can and do sometimes move laterally while proceeding along a lane to an extent that the vehicle moves partially or fully out of the original lane. The consequences of such an occurrence range from minor to significant and include both property damage and personal injury to both the vehicle and occupants thereof as well as other vehicles, persons, and property in the vicinity.

Typical prior art approaches to mitigating or preventing such events on public highways include significant and costly infrastructure improvements. For example, magnetic (or other similarly detectable) strips have been embedded along lane boundaries, which strips can be sensed by on-board sensors and used to warn when a vehicle fails to maintain a lane position (or even to aid in automatically controlling a vehicle to assure lane maintenance). While effective for at least some purposes, the costs of such infrastructure embellishments are significant and particularly so when retrofitting existing roadways with such magnetic or other strips. Another prior art approach promotes the use of small bumps or grooves along the lane boundary and/or road edge. Such undulations induce a bumping or chattering that is usually readily discernable by a driver. Unfortunately, such an approach is only reasonably practical for use outside the boundaries of the lane. As a result, the warning offered by such an approach may, in some circumstances, be provided too late to permit sufficient time for a driver to respond to the signal. Further, such an approach is reasonably practical for use only along the shoulder side of a lane and not as a dividing mechanism between lanes moving in the same direction. A further method is the provision of raised reflectors (so-called “cats eyes”) to delineate the edge of a lane or road. This again represent a significant infrastructure cost. Such reflectors are also often inappropriate for use in cold climates where the use of snowplows for snow removal can cause significant damage to the reflectors. In addition, all of the prior art techniques noted above present problems and additional costs for replacement or special handling when road construction or resurfacing needs arise.

Various prior art approaches are therefore seen to be relatively costly from an infrastructure standpoint and/or relatively limited with respect to their application.

### BRIEF DESCRIPTION OF THE DRAWINGS

The above needs are at least partially met through provision of the lane position maintenance apparatus and method described in the following detailed description, particularly when studied in conjunction with the drawings, wherein:

FIG. 1 comprises a block diagram as configured in accordance with an embodiment of the invention;

FIG. 2 comprises a flow diagram as configured in accordance with an embodiment of the invention;

FIG. 3 top plan diagrammatic view of a lane as configured in accordance with an embodiment of the invention;

FIG. 4 comprises a flow diagram as configured in accordance with an embodiment of the invention;

FIG. 5 comprises a graph depicting functionality as configured in accordance with various embodiments of the invention;

FIG. 6 comprises a graph depicting functionality as configured in accordance with various embodiments of the invention;

FIG. 7 comprises a block diagram as configured in accordance with an embodiment of the invention;

FIG. 8 comprises a detailed sectioned view as configured in accordance with an embodiment of the invention;

FIG. 9 comprises a side elevational view as configured in accordance with an embodiment of the invention; and

FIG. 10 comprises a detailed flow diagram as configured in accordance with an alternative embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, a logic platform in a terrestrial vehicle receives information from appropriate sensors regarding at least one boundary of the lane in which the vehicle is presently moving. The logic platform ascertains when the vehicle moves laterally to within at least a predetermined distance of the lane boundary and enables provision of a signal to the driver. In general, this signal has an intensity that varies with respect to proximity of the vehicle to the boundary. In particular, and depending upon the embodiment, the signal has an intensity that is increasingly less as the vehicle is more proximal to the above-identified predetermined distance and that is increasingly greater as the vehicle is more proximal to the boundary of the lane. Consequently, the intensity of the signal to the driver becomes stronger as the vehicle moves closer to the boundary.

In some embodiments, the signal to the driver includes a haptic (also sometimes called “proprioceptive”) component. Accordingly, the signal is communicated to the driver by physical sensory means such as touch, feel, and/or motion. In some embodiments this haptic signal can be asserted through the steering wheel mechanism. In another embodiment, the haptic signal can be asserted through the driver's seat. If desired, the signal to the driver can also include, or comprise only, a visual or auditory signal.

In some embodiments, the signal can vary depending upon whether the vehicle is moving closer to the side of the road (such as a shoulder) or towards an adjacent lane. For example, the maximum signal intensity for the signal when warning of an approach to an adjacent lane can be greater than the corresponding maximum signal intensity for use when warning of an approach to the side of the road.

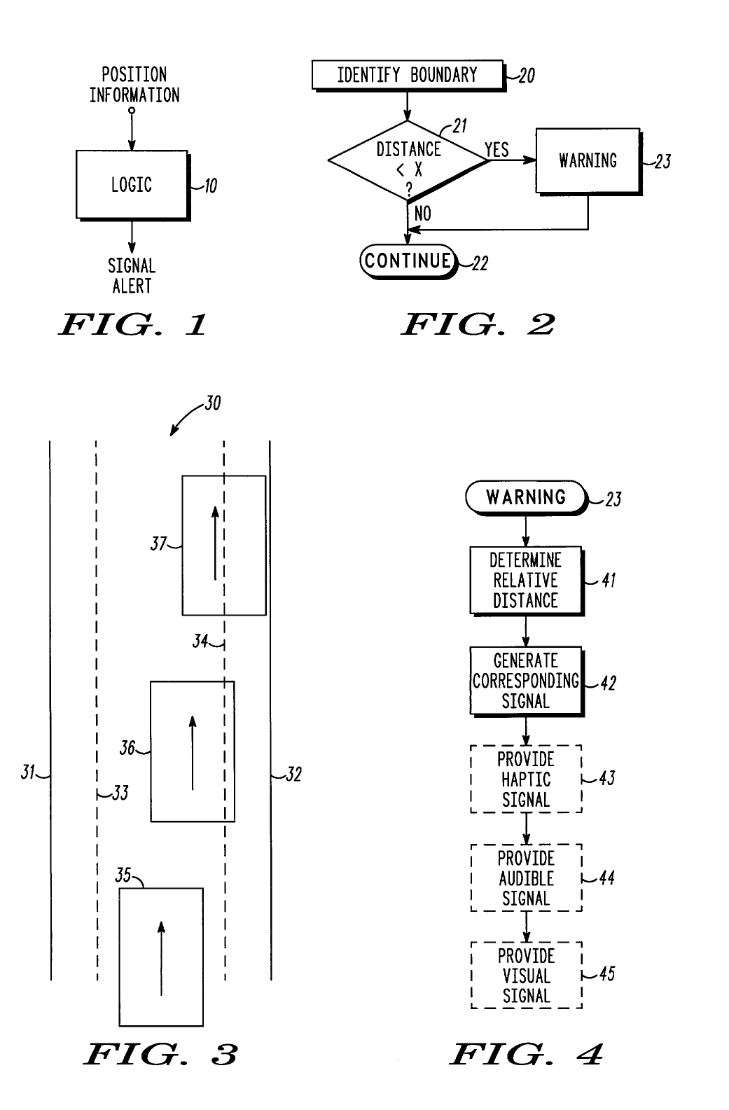

Referring now to FIG. 1, as already noted, a logic unit 10 (such as a microprocessor, microcontroller, or processing equivalent) can serve as a programmable platform that can support the functionality described herein. In general, this logic unit 10 receives position information and provides an alert signal when the vehicle is ascertained to be within a predetermined proximity range of the boundary. The position information can either be specific position information that defines the present distance between the vehicle and the boundaries of the lane or general position information that the logic unit 10 can further process to ascertain the present distance between the vehicle and the lane boundaries.

Such position information can be provided in a variety of known ways. For example, vision-based systems can be used along with pattern-matching techniques to identify various kinds of lane boundaries, including lines (painted or natural) on the roadway, curbs, changes in surface material, snow mounds, and so forth. Other approaches exist that use, for example, radar or other reflective energy techniques. Similarly, there are various known ways to ascertain a present distance of the vehicle from such a boundary including, for example, calibrated vision-based measurements. Because such mechanisms are understood in the art, and further because the precise manner by which such information is developed is relatively unimportant to understanding the present invention, further detailed description of such systems will not be provided here for the sake of brevity and the preservation of focus.

Referring now to FIG. 2, the logic unit 10 serves generally to identify 20 one or more boundaries for a present lane in which the vehicle is moving and to determine 21 whether the vehicle is within or outside a predetermined range or distance from that boundary. For example, and referring momentarily to FIG. 3, a vehicle 35 can be moving in a lane 30 having a left-side boundary 31 and a right-side boundary 32. Either boundary 31 or 32 can be a roadside boundary (such as a shoulder, curb, divider, island, or other alteration in material makeup and which may, or may not, be highlighted by a painted, reflective, or other artificial boundary indicator) or an adjacent lane boundary as is well understood in the art. For each boundary 31 or 32 the system also has an established threshold 33 and 34, respectively, that is a predetermined distance away from the boundary. Such threshold distances 33 and 34 can be static and fixed or can be varied. For example, if desired, a threshold distance can be located further inwardly or outwardly of a given boundary as a function of the kind of boundary itself In such an embodiment, the threshold distances on either side of a given vehicle could be different to reflect different kinds of boundaries (a roadside shoulder as one boundary and an adjacent lane boundary as the opposite boundary, for example). As another example, the threshold distances could be varied as a function of speed. In such an embodiment, the threshold distances could be increased as speed of the vehicle increases and vice versa. These examples are intended to be illustrative only, as there are a great number of variables to which the threshold distance can be correlated to suit a given application.

With continued momentary reference to FIG. 3, it can be seen that a vehicle 35 can be positioned in a lane 30 such that the vehicle 35 is not unduly proximal to either lane boundary 31 and 32. If lateral movement occurs for whatever reason, however, the vehicle (as depicted by reference numeral 36) can move closer to one of the lane boundaries 32 and thereby move within the predetermined range 34 as established for that boundary 32. If the lateral movement continues, the vehicle (as depicted by reference numeral 37) will move closer still to the lane boundary 32 while simultaneously moving further away from the predetermined distance threshold 34 for that boundary 32. These relative positions may be helpful to keep in mind when reviewing the description below.

Referring again to FIG. 2, when the monitored vehicle remains appropriately positioned within its lane, and in particular is not at least within the predetermined distance of either boundary, the system's processes simply continue 22 with whatever other tasks may be assigned thereto, if any (provided, in a preferred embodiment, that the system again rechecks the relative position of the vehicle with respect to the lane boundaries at appropriate intervals, which intervals can be fixed or dynamic as desired). When, however, the distance from the vehicle to the boundary is determined 21 to be less than the predetermined distance to one of the boundaries, a warning is issued 23 to the driver.

With reference to FIG. 4, the nature of the warning 23, in a preferred embodiment, is at least partially dependent upon the relative distance 41 between the vehicle and the boundary in question. In particular, in a preferred embodiment, the intensity of the generated warning signal 42 generally tends to increase as the vehicle moves closer to the boundary and further from the predetermined distance and conversely is served at a decreased level as the vehicle is relatively closer to the predetermined distance and further from the boundary itself.

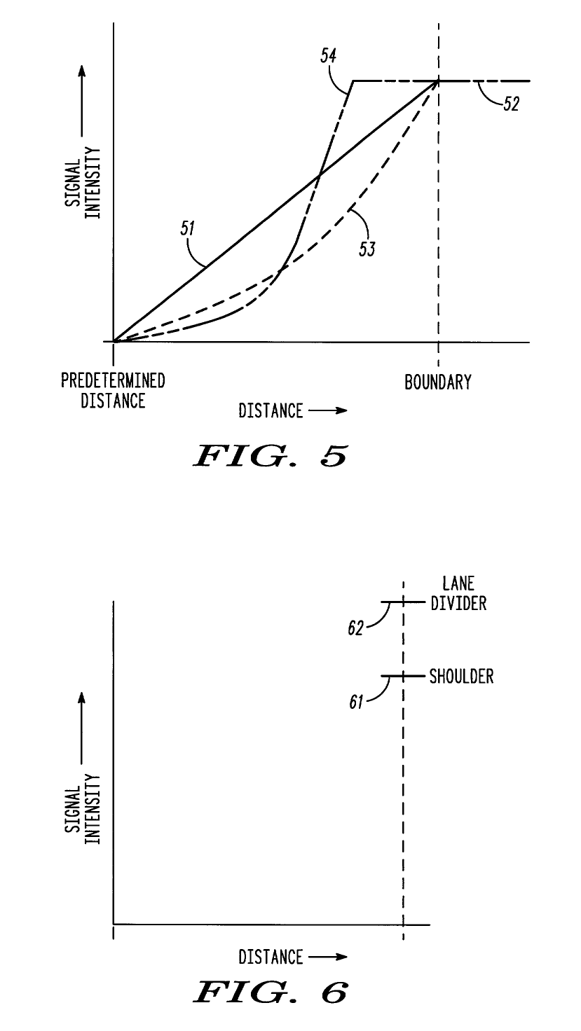

For example, and referring momentarily to FIG. 5, signal intensity can increase linearly to a predetermined maximum intensity as depicted by reference numeral 51. As set forth in this illustration, the maximum signal intensity corresponds to the location of the boundary itself. Depending upon the particular needs of the application, if and when the vehicle continues beyond the lane boundary, the signal can then either remain at the maximum signal intensity level as shown by reference numeral 52 or can decrease abruptly or gradually as appropriate.

The signal intensity can of course be varied in other ways as well. For example, the signal intensity can increase non-linearly and conclude at a predetermined maximum signal intensity value either at the boundary location (as shown by reference numeral 53) or prior to the boundary location (as shown by reference numeral 54), again as desired and appropriate to a given application and context.

Just as it was noted earlier that the predetermined distance can be varied for different boundary conditions, so also can the pattern of signal intensification. For example, a non-linear pattern may be appropriate for use with a roadside boundary whereas a linear pattern that initially increases intensity more rapidly than a non-linear pattern may be appropriate for use with an adjacent lane boundary. As another example, and referring momentarily to FIG. 6, the predetermined maximum signal intensity can also be varied. As an illustrative example, the predetermined maximum signal intensity 62 for use with an adjacent lane boundary can be greater than the predetermined maximum signal intensity 61 as used with a shoulder boundary condition.

In these various ways, and referring again to FIG. 4, a warning signal that varies dynamically with increasing or decreasing proximity to a lane boundary and/or other variables (such as, but not limited to, lane boundary type, vehicle speed, and so forth) is generated 42. In a preferred embodiment, this signal is used to provide 43 a haptic signal to the driver. A haptic signal offers various advantages including a reasonable likelihood of perception by the driver in a variety of driving conditions and also, at least for many individuals, a likelihood of drawing an intuitive correlation between the haptic sensation and the deteriorating lane position situation.

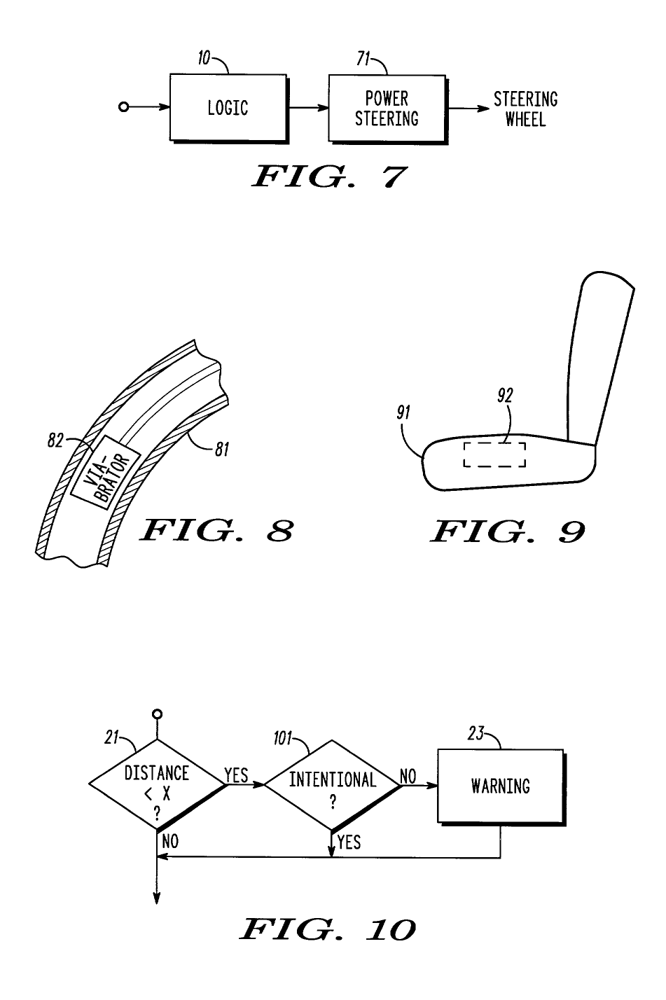

A haptic signal can be proffered in a variety of ways. For example, and referring momentarily to FIG. 7, the logic unit 10 can provide the generated signal to the power steering unit 71 of the vehicle. The power steering unit 71 can be modified to alter steering resistance in response to the logic unit signal. For example, as the warning signal increases as taught above, the steering resistance can be increased as well. As also taught above, the intensity of resistance can vary to reflect relative proximity to the boundary. As an alternative approach, rather than providing increased resistance to steering, one could instead impart a force on the steering wheel that tends to push the steering wheel away from the boundary and back towards the center of the lane. It is not necessary that the force be of sufficient strength to literally lead to a self-correction. The point would be to provide an intuitive sensation to the driver to indicate the drifting of the vehicle.

In another embodiment, and referring now to FIG. 8, a vibration unit 82 (such as an offset motor or other known vibration-creation mechanism) can be disposed within the steering wheel 81 such that the steering wheel 81 itself can be caused to vibrate as a function of the logic unit 10 signal. So configured, vibration of the steering wheel 81 can vary with intensity as otherwise taught above so that, in general, the steering wheel 81 will vibrate more intensely as the vehicle draws closer to the lane boundary. There are other ways to impart vibration to a steering wheel, of course. For example, the vibration-imparting mechanism could be coupled to the steering wheel shaft or column and/or could be applied through appropriate modification of the power steering module.

A steering wheel is utilized to impart a haptic signal to the driver in the two illustrative embodiments described above. A steering wheel constitutes a useful transducer for haptic signals because the driver will usually have at least one hand in contact therewith during most driving activities. The driver will therefore be relatively likely to perceive the haptic sensations when they are provided. Additionally, since the at least one behavior required of the driver in response to the road or lane departure signal is to correct the motion using the steering wheel, then provision of that signal through the steering wheel enables a more direct and potentially intuitive coupling between the signal and the required response.

Other embodiments can of course be offered to impart a suitable haptic signal to the driver of such a vehicle. For example, and referring momentarily to FIG. 9, a vibration unit 92 or other haptic mechanism can be disposed within the driver's seat 91 (either in the seat portion as shown, in the back portion, or in both as desired). So configured, the driver will again receive a haptic sensation when and as the vehicle being driven undergoes degradation of it's lane position with respect to one of the lane boundaries.

Referring again to FIG. 4, in addition to a haptic signal (or, if desired, instead of a haptic signal), an audible signal 44 and/or a visual signal 45 can be provided to the driver to warn of lane boundary proximity. And as with the haptic signal, the audible and/or visual signal can vary in intensity with boundary proximity as otherwise disclosed above. Audible signals can be provided through use of a dedicated transducer that produces a unique sound or sounds used only for lane position maintenance or, as a lesser preferred alternative, through use of sounds that are otherwise available and used in the vehicle for other purposes as well. Similarly, a visual signal can be discrete and uniquely dedicated to warnings regarding lane boundary proximity or can be shared with other features and functions.

So configured, these various embodiments provide for a warning mechanism that will be noticed by a driver with some reliability and that, in general, becomes more intense as the vehicle draws closer to a lane boundary. The warning can intensify linearly or non-linearly as desired, and considerable flexibility exists to customize the various parameters of the warning (including relative and absolute intensity as well as the pattern of intensification) to suit various static design choices and/or dynamic driving condition. Haptic signals are particularly useful in these embodiments though other perceivable signals may be useful as well, alone or in combination. Furthermore, it can be readily appreciated that these various embodiments and benefits are attainable with a variety of boundary identification and vehicle location mechanisms and approaches and are not particularly limited with respect to any specific choice in this regard.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, and referring to FIG. 10, pursuant to a modified embodiment, when the process determines 21 that the vehicle is within the predetermined distance of a lane boundary as described above with respect to FIG. 2, the process can then determine 101 whether such proximity is intentional on the part of the driver. Such intent may be ascertained in a variety of ways. For example, status of the turn signal indicator and/or retinal tracking may indicate that the driver is knowingly moving the vehicle in the direction of the lane boundary. When such circumstances are noted, the process can bypass the provision of a warning 23 and can simply continue as otherwise described above.

We claim:

1. A method, comprising the steps of:
at a terrestrial vehicle that is moving with respect to a lane:
identifying at least one boundary of the lane;
determining when the terrestrial vehicle is moving laterally to at least within a predetermined distance of the boundary of the lane;
providing at least one signal to a driver of the terrestrial vehicle when the terrestrial vehicle is moving laterally to at least within the predetermined distance of the boundary of the lane, such that the signal has an intensity that is increasingly less as the terrestrial vehicle is more proximal to the predetermined distance and increasingly greater as the terrestrial vehicle is more proximal to the boundary of the lane.

2. The method of claim 1 wherein the lane comprises one lane of a two-lane road.

3. The method of claim 1 wherein the lane comprises one lane of a multi-lane road.

4. The method of claim 1 wherein the boundary of the lane comprises a shoulder boundary.

5. The method of claim 1 wherein the shoulder boundary comprises at least one of a curb, a painted line, and a material boundary.

6. The method of claim 1 wherein the boundary of the lane comprises another lane.

7. The method of claim 1 wherein providing at least one signal to a driver includes providing a haptic signal to a driver.

8. The method of claim 7 wherein providing a haptic signal to a driver includes altering steering wheel resistance to rotation.

9. The method of claim 8 wherein the steering wheel resistance to rotation is altered such that the resistance is increasingly less as the terrestrial vehicle is more proximal to the predetermined distance and increasingly greater as the terrestrial vehicle is more proximal to the boundary of the lane.

10. The method of claim 7 wherein providing a haptic signal to a driver includes imparting vibration to a steering wheel of the vehicle.

11. The method of claim 10 wherein vibration is imparted to the steering wheel such that the vibration is increasingly less as the terrestrial vehicle is more proximal to the predetermined distance and increasingly greater as the terrestrial vehicle is more proximal to the boundary of the lane.

12. The method of claim 7 wherein the haptic signal to a driver includes imparting vibration to a driver's seat in the vehicle.

13. The method of claim 12 wherein vibration is imparted to the driver's seat such that the vibration is increasingly less as the terrestrial vehicle is more proximal to the predetermined distance and increasingly greater as the terrestrial vehicle is more proximal to the boundary of the lane.

14. The method of claim 7 wherein providing at least one signal to a driver further includes providing a visual signal.

15. The method of claim 7 wherein providing at least one signal to a driver further includes providing an audible signal.

16. The method of claim 7 wherein providing at least one signal to a driver further includes:
when the boundary of the lane comprises a shoulder, providing at least a haptic signal to a driver of the terrestrial vehicle when the terrestrial vehicle has moved laterally to at least within the predetermined distance of the shoulder, such that the signal has an intensity that is increasingly less as the terrestrial vehicle is more proximal to the predetermined distance and increasingly greater, up to a first predetermined maximum intensity, as the terrestrial vehicle is more proximal to the shoulder; and
when the boundary of the lane comprises another lane, providing at least a haptic signal to a driver of the terrestrial vehicle when the terrestrial vehicle has moved laterally to at least within the predetermined distance of the another lane, such that the signal has an intensity that is increasingly less as the terrestrial vehicle is more proximal to the predetermined distance and increasingly greater, up to a second predetermined maximum intensity, as the terrestrial vehicle is more proximal to the another lane.

17. The method of claim 16 wherein the first predetermined maximum intensity is less than the second predetermined maximum intensity.

18. The method of claim 16 wherein the first predetermined maximum intensity is greater than the second predetermined maximum intensity.

19. The method of claim 1 wherein the at least one signal intensifies non-linearly as the terrestrial vehicle moves from proximity to the predetermined distance to proximity with the boundary of the lane.

20. The method of claim 19 wherein the at least one signal intensifies more rapidly up to a predetermined maximum level as the terrestrial vehicle moves closer and closer to the boundary of the lane.

21. The method of claim 1 and further comprising determining that the driver is intentionally moving laterally and then not providing the at least one signal to the driver of the terrestrial vehicle.

22. The method of claim 1 and further comprising varying the predetermined distance as a function, at least in part, of present speed of the terrestrial vehicle.

23. A lane maintenance device for use in a terrestrial vehicle that is traveling in a lane, comprising:
input means for receiving information regarding a present position of the terrestrial vehicle with respect to at least one boundary of the lane;
logic means for comparing the present position with a predetermined proximity range;
when the terrestrial vehicle is within the predetermined proximity range, providing a driver alert signal having an intensity that at least partially corresponds to a present position of the terrestrial vehicle within the predetermined proximity range, such that the intensity of the driver alert signal is relatively less as the terrestrial vehicle is more distal to the boundary of the lane and relatively greater as the terrestrial vehicle is more proximal to the boundary of the lane.

24. The lane maintenance device of claim 23 wherein the intensity of the driver alert signal varies non-linearly over at least a portion of the predetermined proximity range.

25. The lane maintenance device of claim 23 wherein the intensity of the driver alert signal has a first maximum level of intensity when the boundary of the lane comprises a shoulder and a second maximum level of intensity when the boundary of the lane comprises another lane.

26. The lane maintenance device of claim 25 wherein the first maximum level of intensity is greater than the second maximum level of intensity.

27. The lane maintenance device of claim 25 wherein the first maximum level of intensity is less than the second maximum level of intensity.

28. The lane maintenance device of claim 23 wherein the driver alert signal comprises a haptic signal.

29. The lane maintenance device of claim 28 wherein the haptic signal is imparted through a steering wheel of the terrestrial vehicle.

30. The lane maintenance device of claim 28 wherein the haptic signal is imparted through a driver's seat in the terrestrial vehicle.
